(19) United States
(12) Patent Application Publication
(10) Pub. No.: US 2007/0227160 A1
(43) Pub. Date: Oct. 4, 2007

(54) Hydrogen heat exchanger

(75) Inventor: Richard N. Johnson, Anacortes, WA (US)

Correspondence Address: INGRASSIA FISHER & LORENZ, P.C., 7150 E. CAMELBACK, STE. 325, SCOTTSDALE, AZ, 85251, US

(73) Assignee: The Boeing Company

(21) Appl. No.: 11/227,058

(22) Filed: Sep. 15, 2005

(51) Int. Cl. F17C 9/02; F28F 27/00

(52) U.S. Cl. 62/50.2; 165/96

(57) ABSTRACT

Methods and apparatus are provided for exchanging heat. A heat exchanger is provided which includes a casing, a thermal buffer contained within the casing, and a plurality of fluid conduits. Each of the conduits includes an inlet end configured to receive a fluid, an outlet end configured to provide said fluid, and a heat transfer section coupled between the inlet end and the outlet end, the heat transfer section embedded in the thermal buffer.

### TECHNICAL FIELD

The present invention generally relates to heat transfer, and more particularly relates to heat exchangers.

### BACKGROUND

Aircraft companies have contemplated the possibility of using liquid hydrogen as a fuel source in certain hydrogen-fueled aircraft engines. For instance, the use of liquid hydrogen has been explored with respect to hydrogen-powered fuel cells which act as an auxiliary power unit for high altitude aircraft.

One important consideration in using liquid hydrogen as a fuel source relates to issues that arise in storing and subsequently heating liquid hydrogen. When used as a fuel source, hydrogen is typically stored as a liquid to minimize storage volume and maximize fuel energy needed for a mission. For the engine to utilize hydrogen as a fuel source, however, the hydrogen should be a gas at suitable operating temperatures. In changing the hydrogen from a liquid to a gas, it is desirable to maximize the temperature change the liquid hydrogen undergoes since this helps increase of the heat of vaporization. Because liquid hydrogen is stored at temperatures of approximately 40 R (22 K) a significant amount of energy is needed to raise the hydrogen temperature to values of approximately 520 R (289 K) so that the hydrogen is suitable for combustion in an engine or fuel cell. This energy can be used, for example, to cool other systems on the aircraft. Using this heat sink potential can save fuel used to power conventional electric cartridge heaters used to heat the hydrogen.

In heating the hydrogen from its liquid state to its gaseous state very cold interface temperatures are encountered as the temperature of liquid hydrogen is well below the temperature that liquefies some gases and solidifies some liquids. In ground applications this is not an issue. When liquid hydrogen is heated, heat is absorbed from ambient air. This causes any gases in the air to condense and liquefy. The liquid oxygen and nitrogen, for example, drip onto the ground, and can then easily re-evaporate back into the atmosphere. This condensation is acceptable for ground operations, but is less desirable for aircraft applications.

Accordingly, it is desirable to provide improved techniques and apparatus for heating liquid hydrogen to warmer engine operating temperatures without exposing any other hot fluids used in heat sources to extreme cold temperatures. It would also be desirable if such improved techniques and apparatus could heat the liquid hydrogen without liquefying hot gases or solidifying the hot fluids used in other heat sources located near the liquid hydrogen. Furthermore, other desirable features and characteristics of the present invention will become apparent from the subsequent detailed description and the appended claims, taken in conjunction with the accompanying drawings and the foregoing technical field and background.

### BRIEF SUMMARY

A heat exchanger apparatus is provided which includes a casing, a thermal buffer contained within the casing, and a plurality of fluid conduits. Each of the conduits includes an inlet end configured to receive a fluid, an outlet end configured to provide said fluid, and a heat transfer section coupled between the inlet end and the outlet end, the heat transfer section embedded in the thermal buffer.

### BRIEF DESCRIPTION OF THE DRAWINGS

The present invention will hereinafter be described in conjunction with the following drawing figures, wherein like numerals denote like elements, and

FIG. 1 is a perspective view showing a casing of a heat exchanger according to one embodiment;

FIG. 2 is an assembly view showing some of the internal components of the heat exchanger of FIG. 1;

FIG. 3 is a cut away side view showing a heat exchanger according to one exemplary embodiment;

FIG. 4 is a cross sectional view of the heat exchanger of FIG. 3 taken along line A-A;

FIG. 5 is a cross sectional view of a paraffin melting zone near a first end of a paraffin thermal buffer as liquid hydrogen enters the pathways at the hydrogen liquid inlet;

FIG. 6 is a cross sectional view of a paraffin melting zone in the paraffin thermal buffer as the hydrogen fluid moves along the pathways and changes from a liquid-phase to a gaseous-phase;

FIG. 7 is a cross sectional view of a paraffin melting zone near a second end of the paraffin thermal buffer as gaseous hydrogen fluid approaches the hydrogen gas outlet;

FIG. 8 is a graph showing the relationship of hydrogen temperature along a tube wall versus flow distance along the tube from inlet to outlet; and

FIG. 9 is a diagram an exemplary aircraft propulsion system in which the heat exchanger can be implemented.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Overview

Embodiments of this invention address the issues associated with heating hydrogen liquid to usable operating temperatures without exposing other hot fluids used in heating sources to extreme cold temperatures. Embodiments of this invention can address low temperature heating issues via a parallel flow heat exchanger. The heat exchanger comprises a number of heat sources, a plurality of pathways and a thermal buffer. The heat exchanger can accept heat from at least three independent heat sources: electric radiant heating, hot oil flow, and engine exhaust flow. In one embodiment, a heat exchanger can be used to gasify liquid hydrogen (LH2). The pathways through which the hydrogen fluid flows can be encapsulated in a thermal buffer comprising, for example, a phase change material (PCM) such as paraffin. The PCM material acts as a thermal buffer, keeping the heat exchanger from frosting over, liquefying the exhaust gases or solidifying the hot oil used in the heat sources.

The thermal buffer provides the needed thermal resistance between the cold hydrogen and the heat source fluids, such as engine oil or engine exhaust gas. When the cold hydrogen enters the heat exchanger tubes the thermal difference between the hydrogen and the heat source fluids is the largest. Maintaining a sufficient thermal gradient helps to prevent the heat source fluids from freezing. As the hydrogen absorbs heat and warms up the PCM starts to melt lowering the thermal gradient allowing the hydrogen to warm up to the desired working temperature for the engine cycle. The heat of evaporation and heat gained due to warming are absorbed from the heat source fluids. As a result the heat source fluids are cooled. This allows one or more of the heat source fluids to be reused. Without the PCM, the tubes or pathways used to carry the fluid can be too cold in areas where they are wet with the liquid hydrogen and the working fluid can condense or freeze.

Exemplary Embodiment of A Heat Exchanger

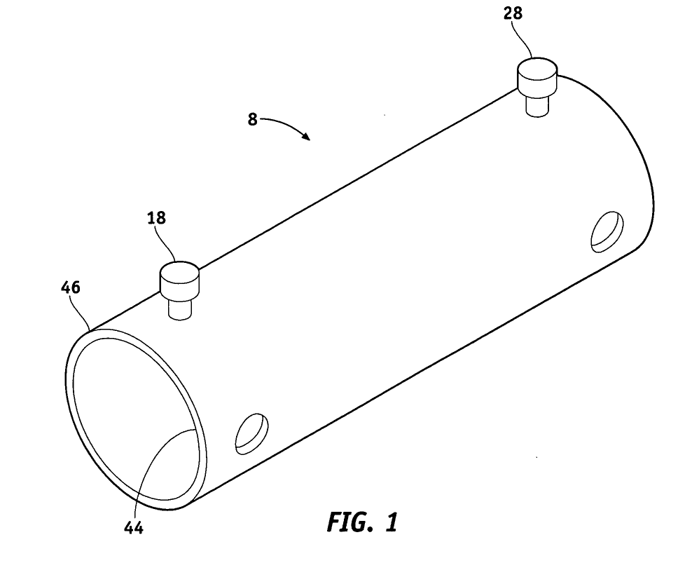

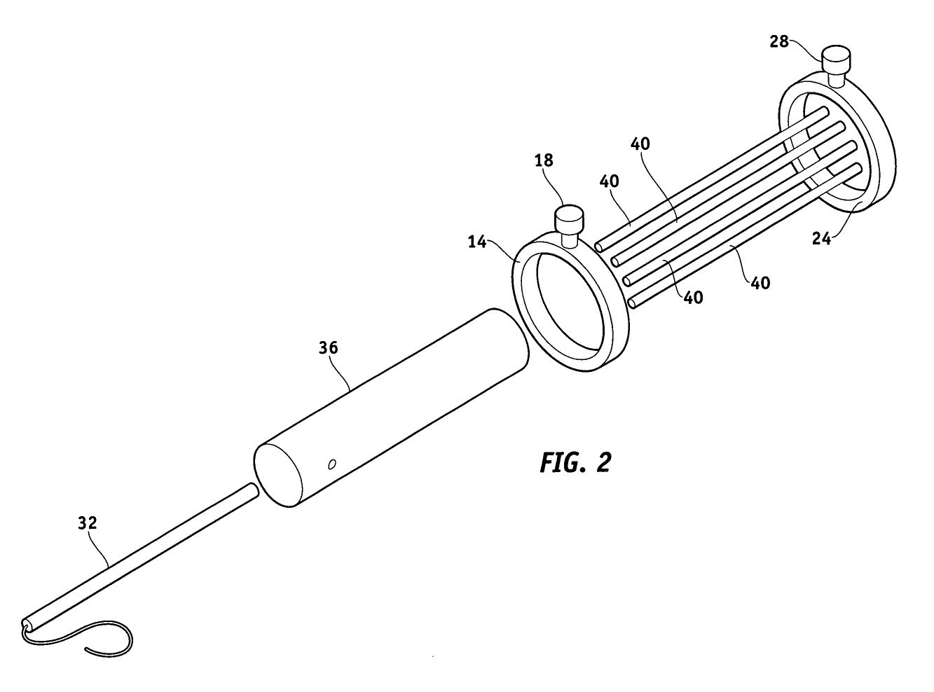

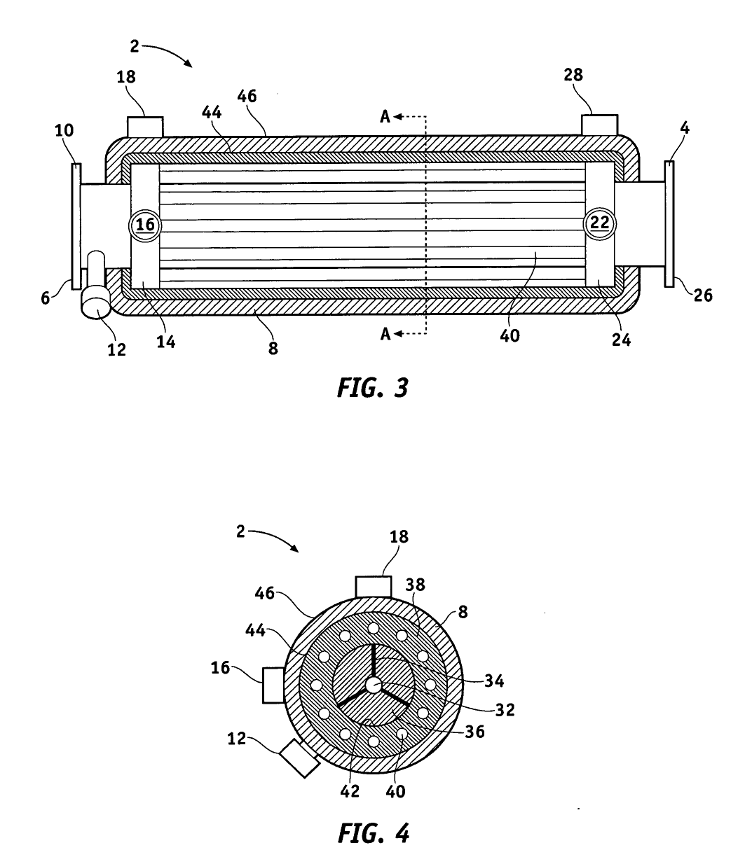

FIG. 1 is a perspective view showing a casing of a heat exchanger according to one embodiment. FIG. 2 is an assembly view showing some of the internal components of the heat exchanger of FIG. 1. FIG. 3 is a cut away side view showing a heat exchanger 2 according to the embodiments shown in FIGS. 1 and 2. While this embodiment is described in the context of a “shell-and-tube” heat exchanger, features of the invention can also be implemented in other heat exchanger configurations where a thermal buffer would improve performance.

In this implementation, the heat exchanger 2 comprises an exhaust gas inlet 4, an exhaust gas outlet 6, a shell or casing 8, a flange connection 10, an electrical connection 12, a gas collection manifold 14, a gas outlet fitting 16, an oil outlet fitting 18, a liquid inlet fitting 22, a liquid distribution manifold 24, a flange connection 26, an oil inlet fitting 28, and fluid pathways 40.

FIG. 4 is a cross sectional view of the heat exchanger 2 of FIG. 3 taken along line A-A. As shown, the casing 8 houses the heat exchanger 2, which comprises an electric radiant cartridge heater 32, supports 34 for the electric radiant cartridge heater 32, an engine exhaust pathway 36 for engine exhaust gas, a thermal buffer 38 and the fluid pathways 40. In one exemplary implementation, the fluid or fuel source for the heat exchanger 2 is described as liquid hydrogen, however, the heat exchanger 2 can use other fuel sources such as liquid oxygen or any fuel capable of being stored in a cryogenic state.

In this embodiment, the heat exchanger 2 is shown as a single tube heat exchanger which integrates three heating sources within a single shell or casing 8. These heating sources include the casing 8 which carries hot oil 45, the electric radiant heater 32 which radiates heat, and the engine exhaust pathway 36 which carries exhaust gas. To provide a frame of reference, components of the heat exchanger 2 will be described with reference to a first end 23 and a second end 17, where the inlet fitting 22 is disposed near the first end 23 and the outlet fitting 16 is disposed closer to the second end 17.

The casing 8 is disposed between the exhaust gas inlet 4 and the exhaust gas outlet 6. The casing 8 encloses a structure comprising the liquid distribution manifold 24 configured to distribute the fluid in the liquid-phase, the gas connection manifold 24 configured to collect the fluid in the substantially gaseous-phase, an electric radiant cartridge heater 32, supports 34 configured to support the electric radiant cartridge heater 32, and the engine exhaust pathway 36 for exhaust gas. The shell or casing 8 surrounds the thermal buffer 38 and connects the oil inlet fitting 28 to the oil outlet fitting 18. The shell 8 forms a hollow annulus that serves as a pathway for carrying hot oil that enters the oil inlet fitting 28 from the engine or other oil cooled device such as a generator. The temperature of the hot oil in the casing 8 can be cooled to appropriate values for a particular engine fuel flow demand and selected oil flow rates. The oil flow rates can be determined for a specific design and determine the specific temperature drop between the inlet fitting 28 and the outlet fitting 16. In one implementation, the temperature of the hot oil in the casing 8 can be cooled, for example, between 30° C. (86° F.) and 65° C. (100° F.).

Hot oil 45 enters the inlet fitting 28 and passes through the hollow annulus formed by the heat exchanger outer shell 46 and oil inner shell 44. The hot oil 45 circulates through the shell 8 and eventually exits at the oil outlet fitting 18 where it is returned to an oil reservoir and recycled through an oil lubrication system. The seams of the shell/casing 8 surfaces can be welded or otherwise sealed such that the fluid is isolated from other hot fluids associated with the heat sources in the casing 8 or hot gases in the engine exhaust pathway 36.

The exhaust gas inlet 4 is an opening located at one end of the heat exchanger 2, and serves as an entry point for exhaust gas 44 from the vehicle's main engine exhaust system. The exhaust gas helps ensure that the hydrogen evaporates and is heated to the required temperature of the engine inlet manifold. In such a system, the volumetric flow rates of the exhaust gas 44 might be 1000 liters/min to 6000 liters/min or more if the engine fuel demand warrants more flow. The pressure drop of the exhaust gas 44 is typically held to a minimum of 1 to 2 kilopascals. The dimensions, such as cross-sectional area, and shape of the exhaust gas inlet 4 and the exhaust gas outlet 6 can be selected based on desired performance characteristics of the heat exchanger 2. The exhaust gas also protects the engine in cases where the oil flow is insufficient or the oil system has failed. Thus, in the event of oil loss or oil circulation problems, the hydrogen can still be heated reliably.

Hot exhaust gas enters the heat exchanger 2 at the exhaust gas inlet 4 and passes through the engine exhaust pathway 36 of the heat exchanger core. The temperature drop of the hot exhaust gas depends upon the flow rate of the exhaust gas. The temperature change of the hot gas between the exhaust gas inlet 4 and the exhaust gas outlet 6 can be, for example, 5° C.

Flange connections 10, 26 connect the heat exchanger 2 to the exhaust system. The flange connection 26 serves as the hot gas interface, and the flange connection 10 serves as a cold gas interface. Although FIG. 3 shows the flange connections 10, 26 as bolted flange connections, other standard joint technologies could be implemented.

The engine exhaust pathway 36 is provided between the electric radiant cartridge heater 32 and the thermal buffer 38. The engine exhaust pathway 36 carries the exhaust gas 44 through the heat exchanger 2 where it eventually exits at the exhaust gas outlet 6 located at the other end of the heat exchanger 2 where the exhaust gas is expelled overboard.

The hot gas warms the hot gas shell 36 which contacts the thermal buffer 38. The electric radiant cartridge heater 32 is held in the center of the hot gas shell 36 by structural supports 34 (not shown in FIGS. 4-6). The hot gas shell 36 is also heated by radiation when the electric radiant cartridge heater 32 is powered.

The electric radiant cartridge heater 32 comprises an electric heat source and can operate, for example, at a temperature between 50° C. and 200° C. The electric radiant cartridge heater 32 draws its power form the vehicle's electric system. The specific amperage and voltages are dependent upon the vehicle's electrical system design. The power is typically set to initiate engine operation during initial start-up when hot oil or exhaust gas are not yet available. The power rating of the electric radiant cartridge heater 32 is preferably designed at three times the maximum energy change of the hydrogen flow rate demand of the engine including the heat of vaporization.

The supports 34 for the electric radiant cartridge heater 32 are located between the electric radiant cartridge heater 32 and thermal buffer 38, and serve to support and suspend the electric radiant cartridge heater 32 within the exhaust engine exhaust pathway 36. The supports 34 can run the length of the fluid pathways 40 and can be made of a material with low thermal and electric conductivity such as pre-cast ceramic

The electrical connection 12 couples an electric power source to the electric radiant cartridge heater 32. The electrical connection 12 provides electrical energy to the electric radiant cartridge heater 32 which the electric radiant cartridge heater 32 converts to heat energy. The electric radiant cartridge heater 32 uses radiation heat transfer to heat the inner tube of the engine exhaust pathway 36 and to initiate the start sequence and ensure sufficient heat is present to meet engine operational demand. In such a system, the heat exchange capacity of the electric radiant cartridge heater 32 might be between 300 and 3000 Watts depending on flow demand of the engine. Feedback control logic (not shown) can be used to operate the heater circuit.

The liquid inlet fitting 22 is coupled to a source (not shown) that stores the fluid, and receives the fluid, such as liquid hydrogen, in a liquid-phase. The source can be, for example, a cold Dewar in the vehicle that stores hydrogen at −251° C.+/3° C. The temperature of the fluid entering the inlet typically ranges from −250° C. to −230° C. Hydrogen stored at −250° C. is eventually heated to a working value of 10° C. to 32° C. Thus, the fluid enters the heat exchanger as a liquid and leaves as a gas.

The liquid inlet fitting 22 is coupled to the liquid distribution manifold 24 which is coupled to the fluid pathways 40. The liquid distribution manifold 24 distributes the liquid to the fluid pathways 40 where the liquid is heated by heat transferred from the electric radiant cartridge heater 32 and the casing 8. As the fluid travels through the fluid pathways 40, the temperature of the fluid can increase, for example, from 50° C. to 90° C. such that the temperature of the fluid exiting the outlet ranges from 50° C. to 90° C.

The fluid pathways 40 are coupled to the gas collection manifold 14 which collects the fluid in a substantially gaseous-phase. The gas collection manifold 14 is coupled to the gas outlet fitting 16 which is configured to output the fluid in a substantially gaseous-phase. The gas is routed to the engine inlet manifold where it is mixed with air or oxygen to be combusted in the engine cycle. In such a system, the flow rate of the fluid is determined by the engine rating and might range, for example, between 10 kg/min to 100 kg/min. The heat absorption capacity of the fluid can range between 500 Watts up to several thousand Watts depending on engine rating.

The fluid pathways 40 are conduits, such as tubes, that are configured to carry the liquid from the liquid inlet fitting 22 to the gas outlet fitting 16 as the liquid changes phase to a gas during a pass through the heat exchanger. The plurality of fluid pathways 40 are preferably embedded or encapsulated in the material of the thermal buffer 38. The fluid pathways 40 can be coupled between the liquid distribution manifold 24 and the gas connection manifold 24. The diameter of the fluid pathways 40, number of fluid pathways 40, and the length of fluid pathways 40 determine the total amount of heat transferred. This heat transfer is preferably set by the desired engine interface demand. Any number of fluid pathways 40 could be used, and the diameter, length, contour and topology of the fluid pathways 40 can be selected to effectuate a desired engine interface demand. A parallel flow configuration of the fluid pathways 40 tends to maximize the inlet temperature differential. Here, “parallel flow” implies that the flow direction of the heated fluid, hydrogen, and the flow direction of the heating fluid, oil and engine exhaust gas are in substantially the same physical direction.

In one implementation, to maximize temperature differential between the liquid inlet fitting 22 and the gas outlet fitting 16, the fluid pathways 40 can be arranged in parallel with respect to each other. The oil 45 path through the casing 8 and the engine exhaust pathway 36 can also be arranged in parallel to the fluid pathways 40, keeping the maximum temperature differentials between the fluid and the hot fluids used as the heating sources. In one implementation, the temperature difference between the liquid inlet fitting 22 and the gas outlet fitting 16 increases across the fluid pathways 40 such that the oil and exhaust gas temperatures are higher than the temperature of the gas as it exits.

The thermal buffer 38 is a layer of material located between the shell 8 and the engine exhaust pathway 36. The thermal buffer 38 is held fixed between the hot gas shell

42 and the inner shell of the oil passage 44. The thermal buffer 38 thermally isolates a fluid fuel source, such as hydrogen, from the heating sources implemented in the shell 8, the electric radiant cartridge heater 32, and the engine exhaust pathway 36. This structure can enable heat transfer without liquefying other hot fluids used by these heating sources. The thermal buffer 38 can comprise any of a number of phase change materials (PCMs) which have a low melting temperature. Examples include, but are not limited to, paraffin wax, salts and other mixtures of material which have a large capacity to store heat and can be designed to achieve the desired thermal conductivity. Such materials should have a large capacity to store heat so that they can be hot when a fluid, such as liquid hydrogen, starts being circulated. The material from which the thermal buffer 38 is constructed is preferably pliable and able to encapsulate the fluid pathways 40. Materials used to construct the thermal buffer 38 can be selected based on temperature compatibility. Material properties should be selected to be compatible with the selected fuel source. The specific heat of the PCM 38 is temperature dependent, and can be determined or set by the PCM temperature between the Hydrogen and the oil.

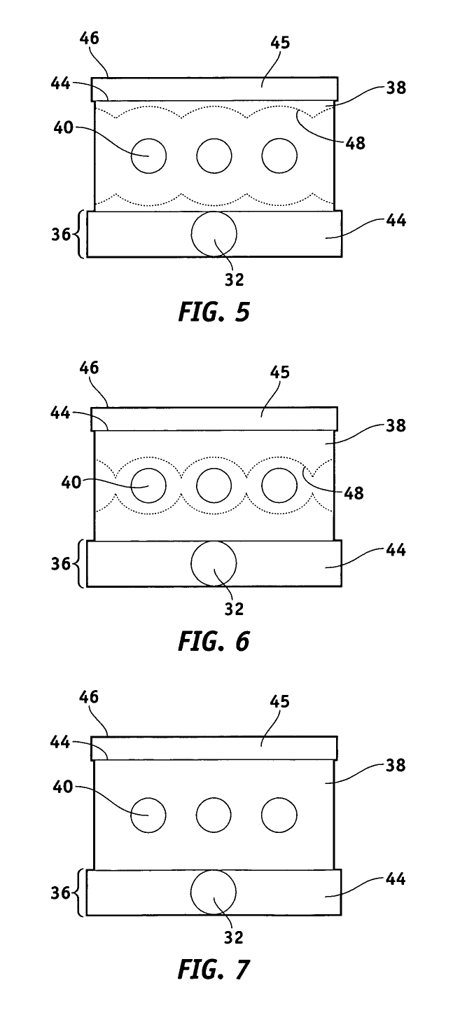

In one example, the thermal buffer 38 may comprise paraffin, and the pathways 40 comprise tubes encapsulated in the thermal buffer 38 and configured to carry the liquid hydrogen while it is being substantially converted to hydrogen gas. Temperature differentials can be maintained between the hot fluids carried by the casing 8 and hot gas shell 36, and the hydrogen. This prevents freezing/condensation of the heating fluids carried by the casing 8 and hot gas shell 36, respectively. The material properties of paraffin allow a hot fluid to melt the paraffin next to hot surfaces, yet, as will be illustrated below with reference to FIGS. 5-7, any paraffin in contact with the portions of the tubes 40 which carry liquid hydrogen remain solid. Thus, as heat is transferred by thermal conduction through the paraffin, the hydrogen will start to warm up. As the hydrogen absorbs heat and changes phase, the melting zone of the paraffin can approach the hydrogen-filled tube wall. Therefore, at the exit of the heat exchanger 2, the paraffin 38 can change to a liquid state, while hot fluid temperature loss can be held to acceptable levels. A parallel flow configuration of the tubes 40 and other heat sources tends to maximize the temperature differential between the liquid inlet fitting 22 and the gas outlet fitting 16.

As will be explained in greater detail below with reference to FIGS. 5-8, the liquid absorbs heat from the thermal buffer 38 as the liquid moves along the fluid pathways 40 in a direction from a second end 17 towards the first end 23 to thereby change the liquid from

the liquid-phase to a substantially gaseous-phase during a pass through the heat exchanger. Heat is transferred through the thermal buffer 38 as the temperature of the fluid increases such that portions of the thermal buffer 38 in the vicinity of the tubes 40 increases in temperature and eventually melts as temperature increases beyond a given temperature. The thermal buffer 38 serves as an interface between the hot gas/oil used to heat the liquid thereby enabling heat transfer without liquefying/solidifying the hot gas/oil. For example, hot gas 44 in the engine exhaust pathway 36 will not liquefy, and hot oil 45 in the casing 8 will not solidify during heat transfer from these heating sources to the liquid hydrogen. Portions of the thermal buffer 38 located near the pathways 40 at the second end 17 melt, while portions of the thermal buffer 38 in contact with the liquid-filled portions of the fluid pathways 40 remain solid.

Operation of the Heat Exchanger

Operation of the heat exchanger 2 in this exemplary implementation will now be described with reference to FIGS. 1-8. FIGS. 5-7 are cross sectional views of a paraffin thermal buffer 38 which illustrate growth of a paraffin melting zone 48 as liquid hydrogen enters the heat exchanger 2 and is substantially converted to gaseous hydrogen during a pass through the heat exchanger. The paraffin melting zone 48 is shown with via dotted lines 48 in the paraffin thermal buffer 38. Areas outside the dotted lines 48 comprise melted paraffin, while the areas between the dotted lines 48 comprise solid paraffin.

Liquid hydrogen enters the heat exchanger 2 at the hydrogen liquid inlet fitting 22. At this point, the liquid hydrogen may be, for example, at a temperature between −251 C. and −230° C. and may be at a pressure between 170 kPA and 205 kPA. The liquid hydrogen is distributed through the liquid distribution manifold 24 into smaller diameter pathways shown as tubes 40. Keeping the hydrogen tube diameters small helps to shorten the tube length needed to boil the liquid hydrogen.

FIG. 5 is a cross sectional view of a paraffin melting zone 48 near a first end 23 of a paraffin thermal buffer 38 as liquid hydrogen enters the tubes 40.

FIG. 6 is a cross sectional view of a paraffin melting zone 48 in a paraffin thermal buffer 38 as the liquid hydrogen moves along the tubes 40 and the hydrogen changes from a liquid-phase to a substantially gaseous-phase midway down the tubes 40. The properties of PCMs such as paraffin allow the hot fluid to melt the paraffin next to hot surfaces near the end of the tubes 40, yet any paraffin in contact with the liquid hydrogen filled tubes 40 remains solid. Thus, as heat is transferred by thermal conduction through the paraffin, the hydrogen will start to warm up and as the hydrogen absorbs heat and changes phase, the paraffin melting zone 48 will approach the walls of the hydrogen gas-filled tubes 40.

As the liquid hydrogen enters and travels down the tubes 40, heat is transferred from the three heating sources which include the casing 8 which carries hot oil 46, the electric radiant heater 32 which radiates heat, and the engine exhaust pathway 36 which carries exhaust gas 44. The liquid hydrogen absorbs heat energy from the thermal buffer 38. This eventually results in hydrogen evaporation thereby altering the phase of the hydrogen from liquid to gas in a pass through the heat exchanger. Boiling heat transfer keeps the tube wall at a constant boiling temperature of approximately 41 R until substantially all of the liquid hydrogen evaporates in a pass through the heat exchanger. Once the liquid is boiled off, the wall temperature of the tubes 40 start to rise based on the heat flux from the heating sources resulting in more melting of the paraffin thermal buffer 38 as shown in FIG. 6. Here the paraffin melting zone 48 has moved closer to the tubes 40.

FIG. 7 is a cross sectional view of the paraffin melting zone 48 near a second end 17 of the paraffin thermal buffer 38 as gaseous hydrogen fluid approaches the gas outlet fitting 16. Here the paraffin of the paraffin thermal buffer 38 has melted, and as the hydrogen gas exits the heat exchanger 2 the wax is melted allowing for some internal convection in the viscous paraffin. At this point, the gaseous hydrogen may be at a temperature between 0° C. and 90° C. and may be at a pressure between 100 kPA and 130 kPA as the gaseous hydrogen exits the heat exchanger 2. Therefore, at the gas outlet fitting 16 of the heat exchanger 2, the PCM can change to a liquid state, while hot fluid temperature loss can be held to acceptable levels. Thus, the PCM buffer 38, when heated by hot fluids, increases in temperature and eventually melts to reduce or eliminate the gap between the hot shell of the exhaust engine pathway 36 and the PCM buffer 38. A gap could form if the thermal expansion of the hot gas shell was greater that the thermal expansion of the PCM thermal buffer 38. As such, the PCM material selection is important. Means to compensate for any gap could easily be added. For instance, a bourdon tube could be installed in the paraffin mix at the hot end of the heat exchanger 2 to compensate for material thermal expansion differences. Finally, as the hydrogen exits the tubes 40 the gas is collected in the gas collection manifold 14, and then routed to the gas outlet fitting 16 which sends the gas to the engine inlet manifold.

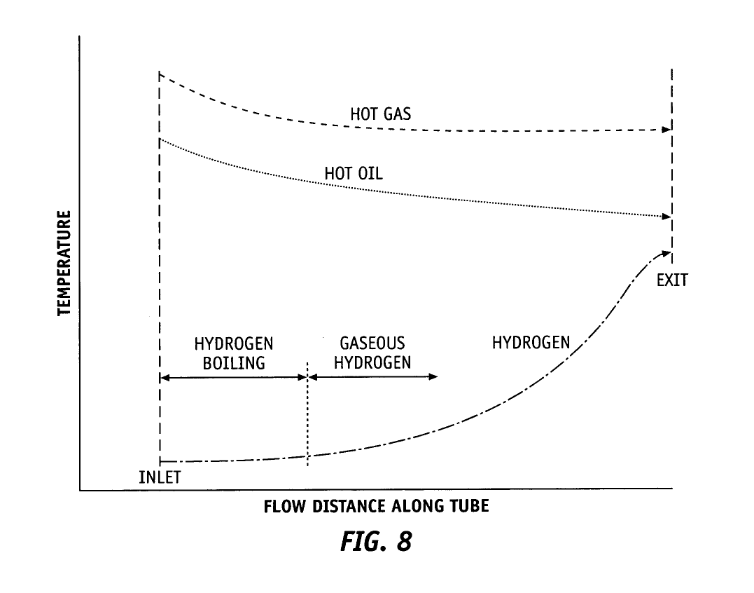

FIG. 8 is a graph showing the relationship of hydrogen temperature versus flow distance along a tube 40 from the liquid inlet fitting 22 to the gas outlet fitting 16, and illustrates heat transfer through the paraffin thermal buffer 38 along the length of the tube 40. As shown, the boiling region holds the wall of the tube 40 at constant temperature until all of the hydrogen liquid fully evaporates in a pass through the heat exchanger. Once the liquid flow is gaseous (or substantially gaseous), the temperature of the wall increases along the remaining length of the tube 40. At this point, the temperature of the hydrogen wall might vary, for example, between −10° C. and 110° C. As the superheated hydrogen gas accelerates down the tube 40, due to the density change and heat flux, the internal heat transfer coefficient increases aiding heat transfer to the hydrogen. The heat transfer coefficient is thus enhanced by the acceleration of the hydrogen gas due to rapid change in density.

In addition to addressing hazards associated with heating liquid hydrogen, this embodiment also tends to minimize part count by providing a simple yet effective design for hydrogen-based engines. Static build up can also be addressed by a well-grounded metal construction.

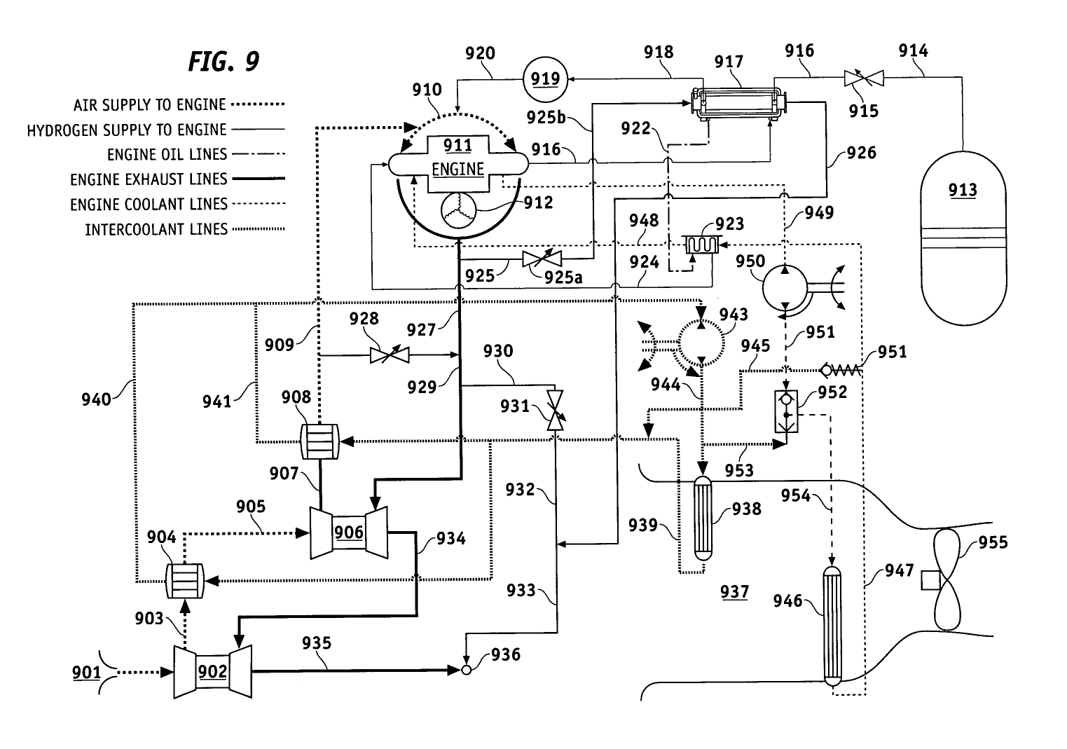

FIG. 9 is a diagram an exemplary aircraft propulsion system in which the heat exchanger can be implemented. The heat exchanger could be implemented, for example, in a section of an aircraft propulsion system having a hydrogen fuel cell. For instance, the heat exchanger could be implemented for warming liquid hydrogen and feeding it to a fuel cell in a High Altitude, Long Endurance (HALE) aircraft. In such an aircraft, the hydrogen is liquefied to minimize its storage volume yet it cannot be fed directly to the fuel cell.

The aircraft propulsion system comprises an inlet 901, a first stage compressor 902, a first intercooler 904, a second stage compressor 906, a second intercooler 908, an engine inlet manifold 910, an engine 911, a fluid storage tank 913 or “Dewar,” a fuel control valve 915, a heat exchanger 917, a fuel reservoir 919, a oil heat exchanger 923, an engine exhaust control 925a, an engine bypass valve 928, a waste gate valve 931, an engine exhaust port 936, a ram air inlet 937, an intercooler radiator 938, an intercooler coolant pump 943, an engine radiator and reservoir 946, an engine coolant pump 950, an intercooler loop temperature control 951, an engine radiator backflow valve 952, and a ground fan 955. The aircraft propulsion system also includes a number of lines which can be used to supply working fluids throughout the system. For instance, the lines 901, 903, 905, 907, 909, 910 can be used to supply air to the engine 911, the lines 914, 916, 918, 920, 921, 924 can be used to supply hydrogen to the engine 911, the line 922 can be used to supply oil to the engine 911, the lines 925a, 926, 931 can be used to carry engine exhaust from the engine 911, the lines 947-949, 951, 954 can be used to supply coolant to the engine 911, and the lines 939-942, 944, 945 and 953 can be used to carry coolant to and from the intercoolers. Alternative embodiments and implementations of the aircraft propulsion system could also include other components and lines which are not shown for sake of simplicity.

The first stage compressor 902 is coupled to the inlet 901, the second stage compressor 906, the first intercooler 904, and the engine exhaust port 936. The first stage compressor 902 receives ram air from the inlet 901 and sends the air to the first intercooler 904. The first stage compressor 902 receives turbo exhaust from the second stage compressor 906 and sends the exhaust to the engine exhaust port 936. The first intercooler 904 is coupled to the first stage compressor 902, the intercooler radiator 938, the second stage compressor 906, and the intercooler coolant pump 943. The first intercooler 904 receives air from the first stage compressor 902, cools it, and sends cooled air to second stage compressor 906. The first intercooler 904 receives a liquid flow from the intercooler radiator 938, heats the liquid and outputs hot coolant which is sent to intercooler coolant pump 943.

The second stage compressor 906 is coupled to the first intercooler 904, the engine 911, and the first stage compressor 902. The second stage compressor 906 receives cooled air from the first intercooler 904. The second stage compressor 906 generates hot which is sent to first stage compressor 902. The second stage compressor 906 receives engine exhaust from the engine 911, and sends it to the first stage compressor 902. The second intercooler 908 is coupled to the intercooler radiator 938, the second stage compressor 906, the engine inlet manifold 910 and the intercooler coolant pump 943. The second intercooler 908 receives liquid flow from the intercooler radiator 938 and generates a hot gas which is sent to second stage compressor 906. The second intercooler 908 also generates a cooled gas 909 which is sent to engine inlet manifold 910, and a hot coolant which is sent to intercooler coolant pump 943. The engine bypass valve 928 is coupled to the second stage intercooler 908 and receives a cooled gas 909 from the second stage intercooler 908.

The engine 911 is coupled to the second stage compressor 906, the intercooler 908, heat exchanger 917, the fuel reservoir 919, and the oil heat exchanger 923. The engine 911 receives cooled gas 909 from the intercooler 908, fuel 920 from the fuel reservoir 919, coolant 949 from the engine coolant pump 950 and hot oil 924, 948 from the oil heat exchanger 923. The engine 911 generates engine exhaust gas which is sent to second stage compressor 906, and outputs engine oil 921 to heat exchanger 917.

The fluid storage 913 provides fuel, such as liquid hydrogen, to the fuel control valve 915 which is coupled between the fluid storage 913 and the heat exchanger 917. The fuel control valve 915 receives the liquid hydrogen from the fluid storage 913, and provides it to heat exchanger 917 in a controlled manner.

The heat exchanger 917 is coupled to the engine 911, the fuel control valve 916, the fuel reservoir 918, engine exhaust control 925a, and the oil heat exchanger 923. The heat exchanger 917 receives engine oil 921 from the engine 911, cools it, and sends the cooled oil to heat exchanger 923. The heat exchanger 917 receives liquid hydrogen from the fuel control valve 916, and evaporates it to produce evaporated hydrogen gas which is sent to the engine inlet manifold 910 via the fuel reservoir 919. The engine exhaust control 25a is coupled to the engine inlet manifold 910 and the heat exchanger 917.

The oil heat exchanger 923 is coupled to the engine 911, the heat exchanger 917, and the engine radiator and reservoir 946. The oil heat exchanger 923 receives cooled oil from the heat exchanger 917, heats it, and sends the “hot” oil 924 to engine 911. The oil heat exchanger 923 also receives a circulated coolant 947 from the engine radiator and reservoir 946 to cool the oil heat exchanger 923.

The waste gate valve 931 is coupled to the engine 911 and the engine exhaust port 936. The waste gate valve 931 receives engine exhaust gas 930 from the engine 911, and sends the exhaust gas to engine exhaust port 936. The engine exhaust port 936 is coupled to the waste gate valve 931 and the first stage compressor 902. The engine exhaust port 936 receives exhaust gas 933 from the waste gate valve 931 and exhaust gas 935 from the first stage compressor 902, and expels the exhaust gases overboard.

The intercooler radiator 938 is coupled to the intercooler coolant pump 943 and the second intercooler 908. The intercooler radiator 938 receives coolant 944 from the intercooler coolant pump 943, and produces a liquid which is sent to second intercooler 908. The intercooler coolant pump 943 is coupled to the first and second intercoolers 904, 908, the intercooler radiator 938, and the engine radiator backflow 952. The intercooler coolant pump 943 receives heated coolant 943 from the first and second stage intercoolers 904, 908, cools the heated coolant 943, and outputs the coolant 944, 953 to intercooler radiator 938 and to the engine radiator backflow valve 952. The engine radiator and reservoir 946 is coupled to the engine radiator backflow valve 952 and the oil heat exchanger 923. The engine radiator and reservoir 946 receives a backflow 954 from the engine radiator backflow 952. The engine radiator and reservoir 946 provides coolant 947 to oil heat exchanger 923.

The engine coolant pump 950 is coupled to engine 911 and the engine radiator backflow 952, and provides coolant 949 to engine 911 and to the engine radiator backflow 952.

The intercooler loop temperature control 951 is coupled to the engine radiator/reservoir 946 and line 939. The intercooler loop temperature control 951 receives a circulated coolant 947 from the engine radiator/reservoir 946, and provides coolant 945 to the second intercooler 908 via line 939.

The engine radiator backflow valve 952 is coupled to the intercooler coolant pump 943 and the engine coolant pump 950, and receives coolant 944 from the intercooler coolant pump 943 and coolant 951 from the engine coolant pump 950.

The ground fan 955 is coupled to the ram air inlet 937, the intercooler radiator 938, and the engine radiator/reservoir 946. The ground fan 955 intakes ram air at the inlet 937, where the intercooler radiator 938 and the engine radiator/reservoir 946 heat the ram air before it enters the first stage compressor 902.

Operation of the Exemplary Aircraft Propulsion System

Ram air is inducted into an inlet 901 by a compressor 902 which discharges the air in a duct 903 which is routed to an intercooler 904. The heat of compression is removed by the coolant fluid in line 939. The cooled air exits the intercooler 904 via line 905 and is then directed into the second stage turbo compressor 906. The hot gas is routed to the second stage intercooler 908 by line 907 where it is cooled by the liquid flow from line 939. The cooled gas is then routed to the engine inlet manifold 910 via line 909. At this point the air charge for the engine 911 is at the proper flow rate, temperature and pressure to initiate combustion once the fuel is mixed.

The hydrogen fuel is stored in a Dewar 913 where an internal pump moves the liquid hydrogen to a fuel control valve 915 via line 914. The liquid hydrogen is then routed to the Hydrogen heat exchanger 917 via line 916. The liquid hydrogen is evaporated to a gaseous state by the heat exchanger by implementing heat exchange with the engine oil supplied to the heat exchanger by line 921 in cases where insufficient heat is available from the engine oil the engine exhaust control 925a opens to insure the hydrogen is fully evaporated. The evaporated hydrogen gas is routed to the fuel reservoir 919 via line 918. The hydrogen gas is mixed with the cooled compressed air and introduced into the engine where is combusted producing the required power to operate the vehicle. The engine also drives the generator 912 for electric energy. The exhaust gases used by the hydrogen heat exchanger are returned to the exhaust system via line 926. Engine 911 exhaust gas is routed via line 927 to a merge with engine by pass control 928 to insure stable engine operation. A waste gate valve is used to control the exhaust energy needed to drive the turbo-compressors 902 and 906. Energy is extracted from the exhaust gas in line 929 by the second stage turbo compressor 906. The turbo exhaust is routed via line 934 to the first stage turbo compressor 902. The exhaust from the first stage turbo compressor 902 is routed overboard via line 935 to an exhaust port 926.

The engine oil is circulated by an engine driven pump (not shown). The engine oil leaves the engine 911 via line 921 to the oil inlet port of the hydrogen heat exchanger 917. The oil looses energy (temperature) to the hydrogen gas and is routed to a oil heat exchanger 923 via line 922. The oil heat exchanger is cooled by a circulated coolant in line 947. The oil temperature returned to the engine 911 via line 924 is at a temperature suitable for engine operation. The heat of vaporization of the hydrogen offsets the demand on the oil coolant and in turn reduces the ram air flow demand for the engine radiator reducing drag and total power demand.

Cooling for the intercoolers 904 and 908 is provided by a coolant circulated trough a ram air heat exchanger 938. Cold coolant is routed to the intercoolers 904 and 908 via line 939. Once the coolant passes through the intercoolers the coolant absorbs the heat of compression of the compressors 902 and 906. the hot coolant is routed via line 940, 941 and 942 to the intercooler Coolant Pump 943. The hot fluid is then routed back to the radiator 938. Fluid expansion is accommodated the intercooler loop temperature control 951 and the engine radiator backflow valve 952 these devices insure that the expansion volume is properly apportions between the reservoir 946 and the two coolant loops.

To initiate engine start up, the electric heater of the heat exchanger 917 is powered up. This allows complete vaporization of the hydrogen before the oil or exhaust gas are hot enough to vaporize the hydrogen.

While at least one exemplary embodiment has been presented in the foregoing detailed description, a vast number of variations exist. For example, while a particular implementation of the heat exchanger has been described above, it should be appreciated that the heat exchanger can be applied to or implemented in any flight application in which a main propulsive engine uses hydrogen and liquid storage is needed. Moreover, the heat exchanger could also be utilized in applications, such as, stationary hydrogen fueled engines where the use of liquid hydrogen storage is employed or in applications, such as, ground and under sea vehicles where liquid hydrogen is being considered as a means to store fuel. The exemplary embodiment or exemplary embodiments are only examples, and are not intended to limit the scope, applicability, or configuration of the invention in any way.

What is claimed is:

1. A heat exchanger, comprising:
a conduit configured to carry a fluid as the fluid changes from a liquid-phase to a substantially gaseous-phase; and
a thermal buffer in thermal communication with the conduit, the thermal buffer configured to provide a thermal interface between the conduit and a heat source.

2. The heat exchanger of claim 1, wherein the conduit comprises a plurality of conduits.

3. The heat exchanger of claim 2, wherein the plurality of conduits are embedded in the thermal buffer such that the thermal buffer surrounds the plurality of conduits.

4. The heat exchanger of claim 2, wherein the plurality of conduits are arranged substantially in parallel with respect to each other.

5. The heat exchanger of claim 2, wherein the heat exchanger comprises a first end and a second end, and further comprising:
an inlet disposed at the first end and configured to receive the fluid in a liquid-phase from a fluid source;
an outlet disposed at the second end and configured to output the fluid in a substantially gaseous-phase, and
wherein the fluid absorbs heat from the thermal buffer as the fluid moves from the first end to the second end to thereby change the fluid from the liquid-phase to the substantially gaseous-phase.

6. The heat exchanger of claim 2, wherein each conduit is defined by a conduit wall, and wherein heat is transferred through the thermal buffer as the temperature of the fluid increases such that the thermal buffer in the vicinity of the conduit walls melts when the temperature of the fluid increases beyond a given temperature.

7. The heat exchanger of claim 2, wherein the thermal buffer is configured to thermally buffer between hot fluids carried by the heat source and the liquid thereby enabling heat transfer without causing the hot fluids to change state.

8. The heat exchanger of claim 5, wherein the thermal buffer comprises first portions located near the second end and second portions near the first end in contact with liquid-filled portions of the conduits, wherein first portions of the thermal buffer melt and the second portions of the thermal buffer remain solid.

9. The heat exchanger of claim 2, wherein the fluid is hydrogen.

10. The heat exchanger of claim 2, wherein the thermal buffer comprises a phase change material.

11. The heat exchanger of claim 10, wherein the phase change material comprises paraffin.

12. The heat exchanger of claim 5, further comprising:
a casing disposed between the inlet and the outlet;
a first manifold, coupled between the fluid source and the plurality of conduits, configured to distribute the fluid in the liquid-phase; and
a second manifold, coupled to the plurality of conduits, configured to collect the fluid in the substantially gaseous-phase,
wherein the plurality of conduits are coupled between the first manifold and the second manifold.

13. The heat exchanger of claim 12, wherein the casing carries hot oil and encloses a structure, the structure comprising:
an electric heater configured to heat;
a plurality of supports configured to support the electric heater;
the thermal buffer; and
a conduitway for exhaust gas defined between the electric heater and the thermal buffer.

14. A heat exchanger, comprising:
a heat source;
an input configured to receive hydrogen in a liquid-phase;
a transport pathway configured to carry the hydrogen as the temperature of the hydrogen increases as the hydrogen travels along the transport pathway and changes into a substantially gaseous-phase; and
a thermal sink configured to thermally buffer the transport pathway from the heat source, wherein the thermal sink increases in temperature as the hydrogen travels along the transport pathway.

15. The heat exchanger of claim 14, further comprising:
means for outputting the hydrogen in a substantially gaseous-phase.

16. The heat exchanger of claim 14, wherein the transport pathway is embedded in the thermal sink.

17. The heat exchanger of claim 14, wherein the hydrogen absorbs heat from the thermal sink as the hydrogen moves along the transport pathway to thereby change the hydrogen from the liquid-phase to the substantially gaseous-phase.

18. The heat exchanger of claim 14, wherein heat is transferred to the thermal sink as the temperature of the hydrogen increases such that portions of the thermal sink near the transport pathway melt when the temperature of the hydrogen increases beyond a given temperature.

19. The heat exchanger of claim 14, wherein other portions of the thermal sink in contact with the transport pathway, which carry liquid hydrogen, remain solid.

20. The heat exchanger of claim 14, wherein the thermal sink comprises paraffin.

21. A heat exchanger, comprising:
a casing;
a thermal buffer contained within the casing; and
a plurality of fluid conduits each comprising:
an inlet end configured to receive a fluid in a liquid-phase,
an outlet end configured to provide said fluid in a substantially gaseous-phase, and
a heat transfer section coupled between the inlet end and the outlet end, the heat transfer section embedded in the thermal buffer.

22. The heat exchanger of claim 21, wherein each of the plurality of fluid conduits is configured to carry the hydrogen as the hydrogen changes from the liquid-phase to the substantially gaseous-phase.

23. The heat exchanger of claim 22, wherein each fluid conduit is arranged substantially in parallel with respect to other fluid conduits.

24. The heat exchanger of claim 22, wherein the casing carries a hot fluid, and further comprising:
a pathway configured to carry exhaust gas, wherein the thermal buffer provides a thermal buffer between the hot fluid carried by the casing, the exhaust gas, and the fluid thereby enabling heat transfer to the fluid without solidifying the hot fluid or liquefying the exhaust gas.

25. An aircraft propulsion system, comprising the heat exchanger of claim 1.

26. An aircraft propulsion system, comprising the heat exchanger of claim 14.

27. An aircraft propulsion system, comprising the heat exchanger of claim 21.
